(19) United States
(12) Patent Application Publication
(10) Pub. No.: US 2004/0249957 A1
(43) Pub. Date: Dec. 9, 2004

(54) Method for interface of TCP offload engines to operating systems

(76) Inventors: Pete Ekis, Santee, CA (US); Charles L. McKnett, Rancho Santa Fe, CA (US); Gregory Randal Ralph, San Diego, CA (US); Allen Andrews, El Cajon, CA (US); Caroline Augustine, Encinitas, CA (US)

Correspondence Address: PAUL, HASTINGS, JANOFSKY & WALKER LLP, P.O. BOX 919092, SAN DIEGO, CA, 92191-9092, US

(21) Appl. No.: 10/844,742

(22) Filed: May 12, 2004

Related U.S. Application Data
(60) Provisional application No. 60/469,705, filed on May 12, 2003.

(51) Int. Cl. G06F 15/16

(52) U.S. Cl. 709/228

(57) ABSTRACT

A method for detecting whether a socket request is directed to a TOE adapter or a generic network adapter is provided. Specifically a set of driver entry points are inserted into a system trap table of an operating system whereby the driver entry points are pointers to driver socket function that replace the original socket functions. The driver socket functions intercept and snoop all socket requests including I/O requests to and from sockets. If the driver socket function determines that the structure of the socket requests contains an encoded pointer, the socket request is passed to TOE hardware for processing. If, however, the driver socket function determines that the structure of the socket requests lacks an embedded pointer, the socket request is passed to generic hardware for processing.

### RELATED APPLICATIONS INFORMATION

### CROSS REFERENCE TO RELATED APPLICATIONS

This application claims the benefit under 35 U.S.C. § 119(e)(1) of the Provisional Application filed under 35 U.S.C. § 111(b) entitled “INTERFACE OF TCP OFFLOAD ENGINES TO OPERATING SYSTEMS,” Ser. No. 60/469,705, filed on May 12, 2003. The disclosure of the Provisional Application is fully incorporated by reference herein.

### BACKGROUND

1. Field of the Inventions

The invention relates generally to computer networks and more particularly to a method for improving system performance and reducing system central processing unit utilization used in conjunction with a device driver for an offload TCP engine network adapter.

2. Background

The development of a layered software architecture has led to efficient data transfer networks and further investment into pioneering I/O bandwidth technologies. In recent years, computer networking I/O technology bandwidth has advanced at a much faster rate than the processing speeds of the host central processing units (CPUs) that run the host based TCP/IP driver stacks used to interface the computer to the network through the NIC. These advances in bandwidth have resulted in extremely high server CPU usage rates for NIC I/O processing, sometimes approaching CPU usage rates of 100% at 1 Gb/sec Ethernet speeds. With all the processing capabilities directed to I/O processing, application processing slows down requiring costly additions of CPU resources.

The industry solution has been to offload all or part of the TCP/IP stack onto the NIC hardware to relieve the host CPU of the I/O burden. Several vendors have introduced or announced the availability of TCP Offload Engines (TOE) NIC hardware solutions. In these new pieces of hardware, TOE components can be integrated onto a circuit board, such as a NIC, to process I/O and remove some of the I/O burden from the CPU, thus increasing throughput on the network. As these networking adapters ate becoming more and more complex, moving more of the functionality down from the operating system to the controller itself, the problem of where to connect the networking driver into the existing host networking stack becomes extremely important.

In the case of full TOE network adapters, the entire Logical Link Control (LLC) and TCP code is contained on the adapter itself. If the network adapter was interfaced in the standard way, each request would, in essence, be processed by both the existing host networking stack and the networking stack of the TOE, canceling most of the performance advantages offered by full TOE network adapters.

The method of interfacing a TOE network adapter into the operating system prescribed by the prior art involves creating a filter driver to intercept requests and redirect the requests to the adapter, thereby bypassing part of the host networking stack. This filter service strategy works well for some operating systems, particularly Microsoft's Windows® based operating systems, but falls apart on many of today's high end operating systems, for example Sun Microsystems' Solaris®, which do not allow filter drivers to be inserted between all layers of the networking stack. In these cases, it is not possible to insert a filter driver at the top of the kernel socket module. A conventional method for interfacing of a TOE network adapter to the operating system requires inserting a filter driver at the bottom of the TCP stack as shown in FIG. 1. More specifically, FIG. 1 illustrates the path a user application network socket request 101 can take to reach a network line 120. The request 101 passes through a user space sockets library 102, a system trap table 104, and a kernel TCP/IP driver 106 prior to reaching a TCP offload filter driver 108 where it is determined whether a generic network adapter 114 or a TCP offload network adapter 116 is present in the computer system. This method is not desirable because the kernel's TCP/IP driver 106 continues processing requests and, if a TOE network adapter is present, the TCP offload network interface driver must discard at least part of the TCP work already done in order to present requests to the TCP offload engine network adapter 116 into the proper format. This approach obviously negates at least part of the benefits gained by offloading the TCP processing because the host networking stack continues the TCP processing, loading the host CPU with I/O processing requests.

Ultimately, networks should perform in a manner equivalent to the capabilities currently realized by the host computer. Therefore, a method is needed that will improve system performance and reduce CPU utilization when used in conjunction with a device driver for a fill offload TCP engine. The present invention, as described in detail below, solves this problem by presenting a method for interfacing TCP Offload Engines into an operating system, including full offload TOEs that place all or most of the TCP processing in hardware and so called partial TOEs that attempt to utilize a portion of the operating system TCP/IP stack in conjunction with the hardware accelerated TOE.

### SUMMARY OF THE INVENTION

In order to combat the above problems, the systems and methods described herein provide for interfacing TCP Offload Engines (TOE) into an operating system to improve system performance and reduce CPU utilization by inserting a set of driver entry points at the system trap table of the operating system thus allowing the socket request to be diverted to either a generic network adapter or the TOE adapter at the earliest level to ensure efficient processing.

In one embodiment, user application network socket requests are processed to determine if the socket request is directed to a generic network adapter or a TCP offload engine network adapter. If the socket request is directed to a TCP offload engine network adapter, the socket request is sent to the TCP offload engine network adapter for processing, thus bypassing the computer's central processing unit and significantly increasing the computer system's performance. If the socket request is directed to a generic network adapter, the socket request is processed by the operating system network stack. Thus, the system and method described herein take full advantage of the capabilities offered by TOE hardware.

In another embodiment, a method for detecting whether a socket request is directed to a TOE adapter or a generic network adapter is provided. Specifically, a set of driver entry points are inserted into a system trap table of an operating system whereby the driver entry points are pointers to driver socket function that replace the original socket functions. The driver socket functions intercept and snoop all socket requests including I/O requests to and from sockets. If the driver socket function determines that the structure of the socket requests contains an encoded pointer, the socket request is passed to TOE hardware for processing. If, however, the driver socket function determines that the structure of the socket requests lacks an embedded pointer, the socket request is passed to generic hardware for processing.

### BRIEF DESCRIPTION OF THE DRAWINGS

Preferred embodiments of the present inventions taught herein are illustrated by way of example, and not by way of limitation, in the figures of the accompanying drawings, in which:

FIG. 1 is a block diagram of a conventional system configured to interface a TCP offload engine network adapter into an operating system via a user space socket library;

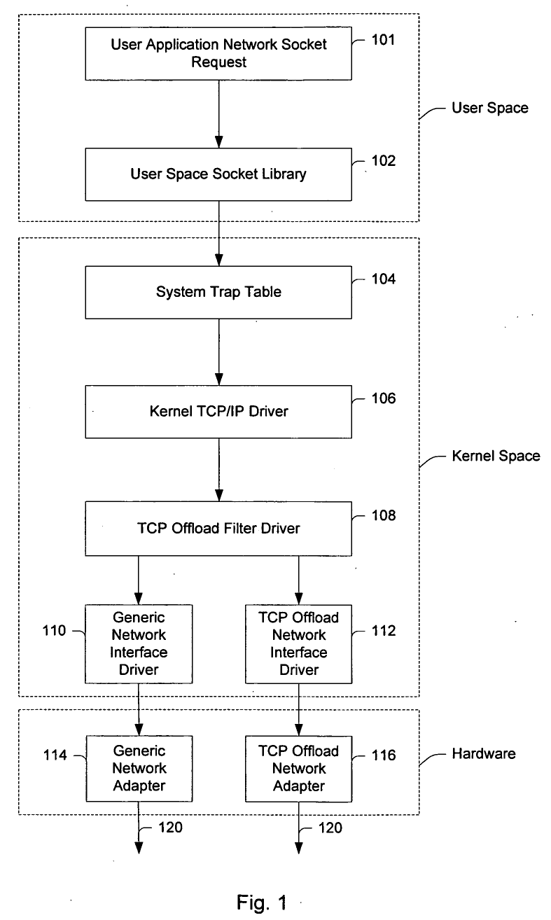

FIG. 2 is a block diagram of a system configured to interface a TCP Offload Engine with an operating system through the replacement of a traditional host protocol stack in a system trap table with a TCP offload engine protocol stack;

FIG. 3 is a flowchart illustrating an initialization socket replacement function executed in accordance with the present invention;

FIG. 4 is a flowchart illustrating a bind processing socket replacement function executed in accordance with the present invention;

FIG. 5 is a flowchart illustrating a listen socket replacement function executed in accordance with the present invention;

FIG. 6 is a flowchart illustrating a accept socket replacement function executed in accordance with the present invention;

FIG. 7 is a flowchart illustrating a connect socket replacement function executed in accordance with the present invention;

FIG. 8 is a flowchart illustrating a receive socket replacement function executed in accordance with the present invention;

FIG. 9 is a flowchart illustrating a receive message socket replacement function executed in accordance with the present invention;

FIG. 10 is a flowchart illustrating a read socket replacement function executed in accordance with the present invention; and

FIG. 11 is a flowchart illustrating a close socket replacement function executed in accordance with the present invention.

### DETAILED DESCRIPTION OF THE PREFERRED EMBODIMENTS

In the descriptions of example embodiments that follow, implementation differences, or unique concerns, relating to different types of systems will be pointed out to the extent possible. But it should be understood that the systems and methods described herein are applicable to any type of network system.

In one embodiment, a method is provided for interfacing TCP Offload Engines (TOE) into an operating system to improve system performance and reduce CPU utilization by inserting a set of driver entry points at the system trap table of the operating system. Generally, the original pointers in the trap table are replaced with driver entry points (or addresses) pointing to driver socket functions. By replacing all pointers to original socket functions in the trap table with driver entry points (pointing to driver socket functions), incoming socket requests may be intercepted thus allowing the driver socket function to snoop the incoming socket request to determine whether the socket request is directed to generic hardware or TOE hardware. If the socket request contains a special indicator, namely an encoded pointer in a private field of the socket request structure, the socket request is immediately passed to the TOE hardware for processing. Otherwise, the socket request is directed to generic hardware and therefore passed on to the original socket function for processing.

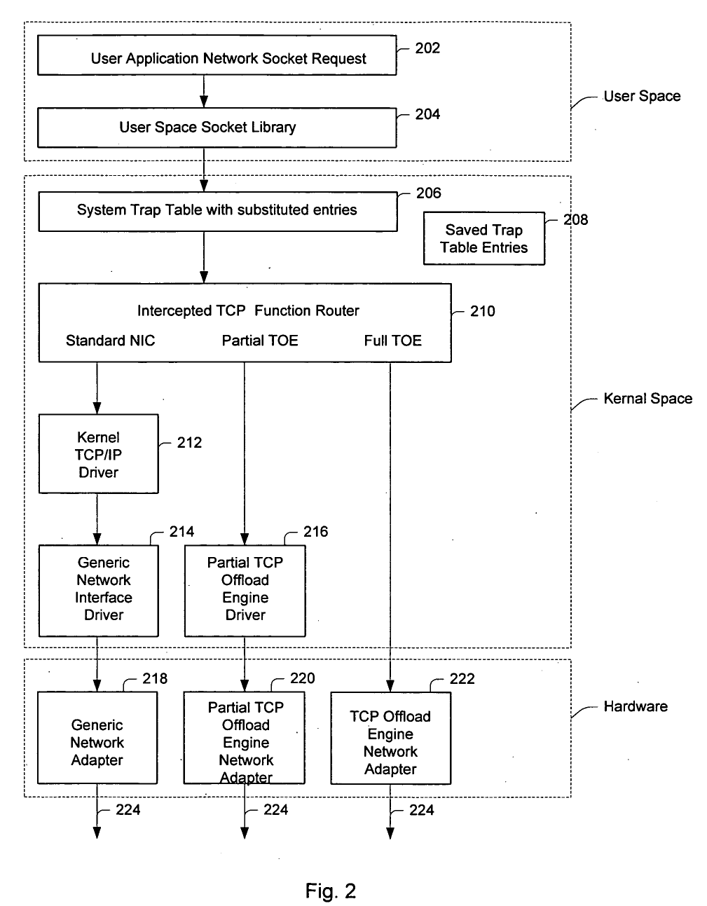

FIG. 2 is a block diagram of a system configured to interface a TCP Offload Engine with an operating system through the replacement of the original socket functions in a system trap table with a set of driver entry points directed to TCP offload engine socket functions. The optimal layer to interface a TOE is as close to the upper layer of the kernel space as possible. The system trap table is an optimal layer. Thus, placement of the interface of a TOE driver in a system trap table provides the TOE with fill access to kernel operating system calls enabling the TOE to operate at an elevated execution priority, which is desirable for all device drivers. For exemplary purposes, the description of the present invention is described using the operating system of Solaris®, available from Sun Microsystems, Inc. Additionally, when the TCP offload engine is described as a partial TOE, a software layer interface to the partial TOE driver will be described in terms of a Berkeley Software Distribution (BSD) network stack to perform functions not present in the partial offload hardware on the partial TOE network adapter. There are slight differences between the Solaris® operating system and the BSD software layer that requires changing some Solaris® arguments to match those specified by the BSD software layer. Additionally, the BSD software layer may be replaced by hardware in a full TOE network adapter implementation. The Solaris® operating system and the BSD network stack are for exemplary purposes only, and in no way act to limit the present invention or embodiments from use with other operating systems or network stacks.

a. Replacing the Original Pointers in the System Trap Table with Driver Entry Pointers

The system trap table is used by operating systems to transition from the user space to the kernel space. Additionally, the system trap table is the highest possible layer in kernel space wherein a user application network socket request can be intercepted. By way of background, a trap table resides in the kernel space and contains a list of kernel functions addresses. Because the user space cannot execute a function in the kernel space by directly calling the function, a software interrupt is triggered. Thus, the addresses contained in the system trap table represent kernel functions pointers that the kernel will call to handle specific software interrupt requests from the user space. Specifically, each request from the user space passes a numerical id to the kernel space. This id represents the offset index into the system trap table. For example, an id=1 represents the first entry in the trap table list and a id=5 represents the fifth entry in the trap table. Thus, when the user space needs to request service from the kernel space, a software interrupt is triggered and the id is passed representing the specific function to be executed in the kernel space.

In accordance with the present invention, in order to direct socket requests to the proper hardware device, the original function pointers in the trap table are replaced with driver entry points. The driver entry point is a pointer to a driver socket function for execution. For example, the driver entry points may be replaced on a request by request basis. Specifically, the driver in accordance with the present invention may intercept request with an id=5. Thus, the function address would be recorded and the function originally found in the fifth entry of the trap table is replaced with the address of the driver socket function. As such, when the kernel executes the function found in the fifth entry it is actually calling the driver socket function (also referred to herein as replacement socket functions) instead of the original socket function. Alternatively, all the original pointers may be replaced with driver entry points when the hardware driver is loaded. It is important to note that, the system trap table socket functions of the operating system are replaced with the socket functions of the TOE hardware, also referred to herein as driver socket functions, while the original trap table pointers for processing socket functions are saved in a secondary table for utilization or reinstallation.

b. Directing Socket Requests via Replacement Socket Functions

Generally, when a socket is created it represents an allocation of memory where basic socket information is stored and not yet associated with any data path or hardware. Once the socket is created, a kernel call is made to connect or bind the socket to a remote IP address. At this time that the kernel looks to a system routing table to determine which path and thus which network adapter will be used to send and receive data for this socket. If that path is directed to a TOE network adapter, a driver program will set an encoded pointer in the socket structure itself to indicate that all I/O traffic for that socket will use the TOE network adapter. This is possible because the driver is capable of intercepting all socket related kernel calls at the trap table. From that point on, every socket request sent from the user space will have a socket structure indicating the path of the socket request. As such, when the driver socket function intercepts the socket request, it simply looks at the encoded pointer in the socket structure associated with the socket request to determine if the socket request should be passed to the TOE network adapter or passed on to the original socket function for processing by a generic network adapter.

FIG. 2 illustrates the above described process in further detail. As shown in FIG. 2 and described above, the TOE hardware first locates the operating system's system trap table 206 and replaces the original socket functions with driver entry points pointing to replacement socket functions (not shown). Examples of the replacement socket functions, for a Solaris® operating environment, include but are not limited to::

Bind, Listen, Accept, Connect, Close, Shutdown, Read, Receive, Receive_From, Receive_Message, Write, Send, Send_Message, Send_To, Get_Peer_Name, Get_Sock_Name, Get_Sock_Opt, Set_Sock_Opt.

Specifically, these replacement socket functions and their specific process flow are described in detail below. It is important to note that for each of these functions, there are well defined arguments that are documented by various texts. In each operating system, there may be slight modifications to the arguments of each socket function.

Once the original socket functions have been replaced, a user space application sends a user application network request 202 to user space socket library 204. The user space socket library 204 passes the request to the system trap table 206 in kernel space. When a trap table entry is called, control is passed to the function pointed to the particular driver entry point. Additionally, a socket request structure, having a pointer to specific request information (depending on what the function is supposed to do), is also passed to the replacement socket function pointed to by the driver entry point.

Importantly, the socket request structure includes addressing information (IP Address) needed to determine whether the socket request is directed to a TOE adapter or to a generic adapter. Specifically, if the replacement socket function examines the socket request structure (also referred to as the Solaris socket structure) and determines that the socket request is directed to a TOE adapter, the socket request 202 is quickly formatted to the TOE hardware's specifications and immediately passed by the intercepted TCP function router 210 to the full TOE network adapter 222 without any further processing. This results in no duplication of processing, thus allowing the acceleration provided by the TOE hardware to be fully utilized. Upon receipt by the full TOE network adapter 222, the TOE hardware formats the request and the request is transmitted to network line 224.

More specifically, the replacement socket function is configured to allocate a BSD socket structure, fills the BSD socket request structure in with information contained in the Solaris socket structure, and creates a “mapping” structure. The mapping structure contains pointers to both the Solaris socket structure and the BSD socket structure. This allows either structure to be quickly located give the other. The address of the mapping structure is saved in the socket request structure's “private” field. As such, when subsequent socket requests are sent by the operating system for that structure, the corresponding BSD socket located and can immediately forward the request to the TOE adapter.

If, however, the replacement socket functions of system trap table 206 determines that the socket request 202 is targeted to a generic network adapter 218, the request 202 is passed by the intercepted TCP function router 210 to the kernel TCP/IP driver 212 to be further processed by the operating system's network stack. The kernel TCP/IP driver 212 configures the request 202 into a format understandable by the generic network interface driver 214. The generic network interface driver 214 then transmits the formatted request 202 to the generic network adapter 218. Upon receipt by the generic network adapter 216, the request is transmitted to network line 224. It should be noted that the replacement socket function include a pointer to the original socket function to which a socket request is forwarded when determined that the socket request is directed to a generic adapter 218.

Furthermore, if the replacement socket functions of system trap table 206 determines that socket request 202 is targeted to a partial TOE network adapter 220, the socket request 202 is immediately passed by the intercepted TCP function router 210 to the partial TCP offload engine driver 216. As the partial TOE network adapter 222 does not process the request completely, the partial TCP offload engine driver 216 requires some use of the CPU for processing. Thus, partial TCP offload engine driver 216 processes the socket request 202. Although partial TOE driver 216 requires some use of the CPU, the partial TOE network adapter alleviates much of the load on the CPU and thus operates to increase overall system performance. Upon receipt from the partial TOE network adapter 220, the partial TOE hardware completes the formatting of the request and the request is transmitted to network line 224.

In one embodiment, sockets for the operating system and the TOE hardware will both be created during processing certain requests. A mapping of the Solaris socket and the BSD socket must be maintained in order to uphold context during processing as described above. Furthermore, in the exemplary Solaris® operating system, the private field of the socket request structure is initialized with a pointer to the socket mapping structure and OR'd with a binary ‘1’, making the pointer an odd number and easy to distinguish from the operating system's pointers saved in the socket structure. This provides a way for the driver to quickly locate the BSD socket associated with each Solaris socket once the mapping has been created by either the bind or connect call. All other calls by the Solaris operating system provide a Solaris socket as the first argument. The network adapter driver can extract the mapping information pointed to by the private field of the Solaris socket so that it can immediately have access to the BSD socket. The BSD socket is always passed to the corresponding BSD function.

In summary, the system trap table 202 having replacement socket functions becomes part of the application in the kernel space. Optionally, a corresponding function table 208 may reside in the kernel space along side the system trap table with replacement socket functions 206 saving the original socket functions for subsequent user or future reinstallation when the TOE driver is unloaded. As is explained in greater detail below, the replacement socket functions of system trap table 206 are functionally configured to intercept the user application program request sent to the TCP/IP stack and pass the request directly to the TOE network adapter, thus bypassing the TCP/IP stack in its entirely.

The interposition of the replacement socket functions in a system trap table does not result in a measurable degradation in performance for socket requests to generic network adapters. However, for those requests directed to full and partial TCP offload engines, this methodology allows the generic network interface driver 212 and the kernel TCP/IP driver 308 to be entirely bypassed, thus resulting in a significant performance increase of the system.

c. Exemplary Replacement Socket Functions and their Process Flows

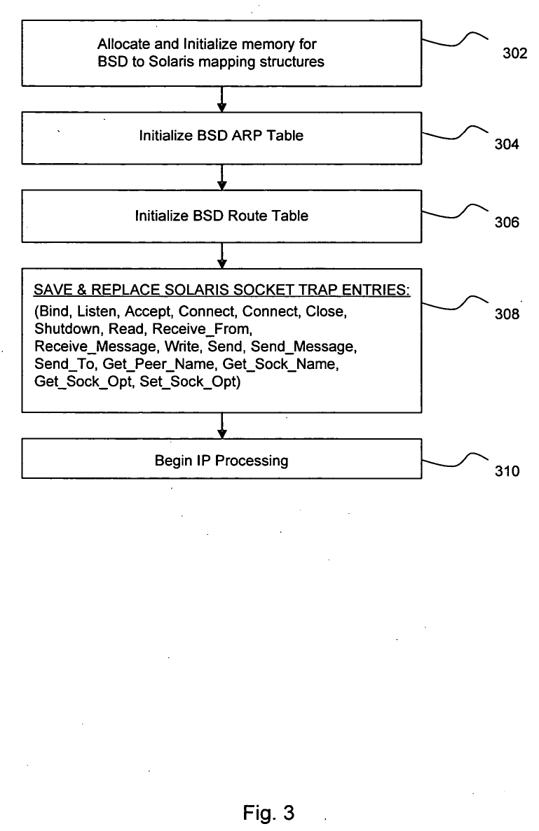

FIGS. 3 through 11 illustrate the process flow for each replacement socket function. The following is an exemplary description of the processing needed for each replacement socket function (implemented in a Solaris environment) before calling the matching BSD function. The replacement of the Solaris socket with the BSD socket before calling the appropriate BSD function is preferably performed first and in the same manner and will not be included in the description of each replacement socket function.

FIG. 3 is a flowchart illustrating the process flow for initializing a socket replacement function. First, memory is allocated and initialized as shown in step 302 for the BSD to Solaris mapping structures. Then, in step 304, the BSD Address Resolution Protocol (ARP) table is initialized. Following which, the BSD Route table is initialized in step 306. At this point, the standard Solaris trap table entries are saved off to a memory location so they will be available for future replacement. The Solaris trap table entries are replaced with driver entry points and their corresponding replacement socket functions, as shown in step 308, for the following functions:

Bind, Listen, Accept, Connect, Close, Shutdown, Read, Receive, Receive_From, Receive_Message, Write, Send, Send_Message, Send_To, Get_Peer_Name, Get_Sock_Name, Get_Sock_Opt, Set_Sock_Opt.

After the trap table entries for the replacement socket functions have been successfully replaced, initialization is complete and TCP/IP processing can commence (Step 310).

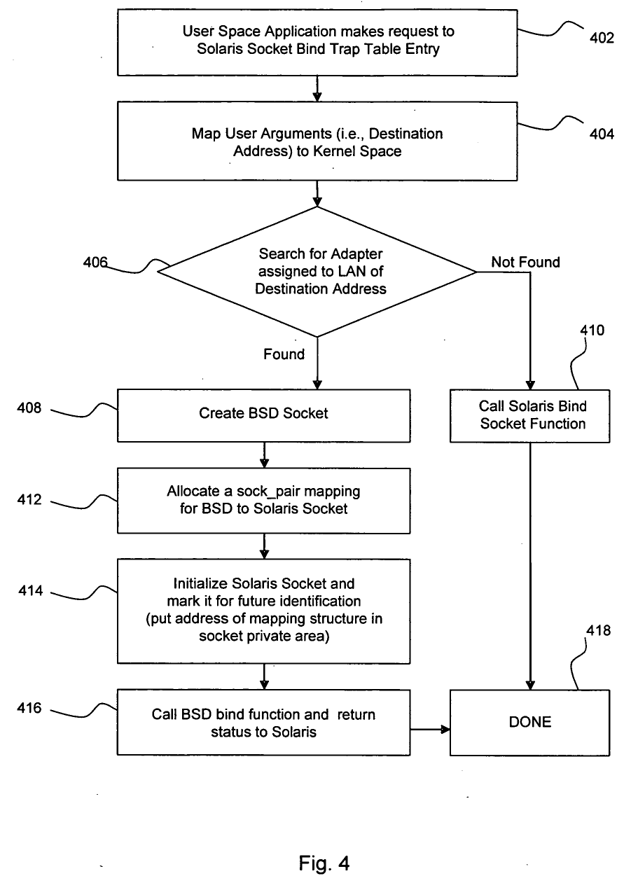

FIGS. 4 through 11 illustrate exemplary process flows for replacement socket functions depicted in step 308 of FIG. 3. FIG. 4 is a flowchart illustrating the process flow for the bind processing replacement socket function. The bind socket function sets a local network transport address for a socket. As shown in step 402, the user space application makes a request to the Solaris bind socket function that is routed to the corresponding trap table entry. The user arguments, including a destination address, is mapped to kernel space in step 404 and further examined to determine if the network adapter's address is specified (Step 406). If the address is not found, the user space application request is passed through to the operating system's network stack as shown in step 410. If the address supplied matches the address of a TOE network adapter, a BSD socket is created in step 408. After the BSD socket has been created, a mapping structure is allocated and initialized with the Solaris socket handle and the BSD socket pointer (Step 412). In step 414, the Solaris socket is initialized and marked for future identification as follows. A pointer to the mapping structure is saved in the private field of the Solaris socket for reference by future socket calls. Then, the address structure is modified from a Solaris address to a BSD address by copying the address information, excluding the length field, to a locally allocated BSD structure. The length argument (namelen) is then copied to the length field of the BSD address. The BSD bind function can now be supported in the TOE hardware. Hence, as shown in step 416, the BSD bind function will be called and the status returned to the operating system, thus completing the bind socket function processing in step 418.

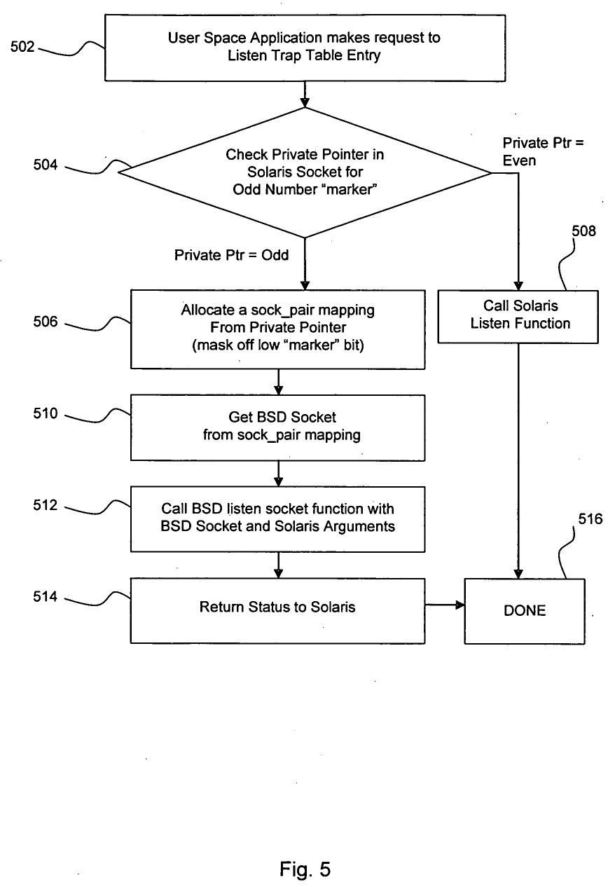

FIG. 5 is a flowchart illustrating the process flow for the listen replacement socket function. The listen replacement socket function is designed to prepare a socket to receive connections socket. When the user space application makes a request to the Solaris socket bind socket function that is routed to the corresponding trap table entry, as shown in step 502, the listen socket function first checks the Solaris private field in step 504 to determine whether the socket provided is targeted for the TOE hardware or a generic network adapter. To determine whether the socket provided is targeted for the TOE hardware or a generic network adapter, the listen socket function checks the “marker” of the Solaris private field. If the “marker” of the Solaris private field is an even digit, the “marker” indicates that the socket is not one of the TOE driver's socket functions and the call is passed immediately to the Solaris network stack as shown in step 508. If the “marker” of the Solaris private field is an odd digit, the “marker” indicates the listen request should be processed by the TOE adapter. The request is passed to step 506 where a sock_pair mapping is allocated from the private pointer with the least significant “marker” bit masked off, thus creating a BSD socket in step 510. As shown in step 512, the BSD listen socket function may be called directly with the Solaris arguments since the arguments for the Solaris and BSD listen socket functions call map directly (excluding the version argument, which in not used by BSD). Finally, the resulting status is returned to Solaris in step 514, concluding the listen socket function processing in step 516.

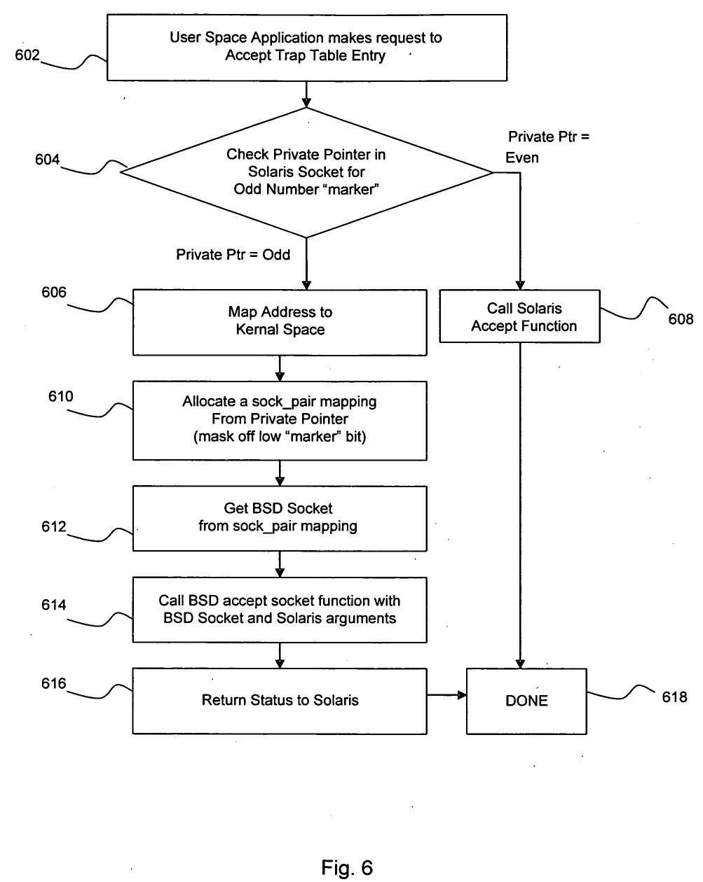

FIG. 6 is a flowchart illustrating the process flow for the accept replacement socket function. The accept replacement socket function waits for incoming connections. When the user space application makes a request to the Solaris accept socket function that is routed to the corresponding trap table entry (step 602), the accept socket function checks the private field of the Solaris socket to determine whether the socket is mapped to the BSD socket indicating that the socket is targeted for the TOE hardware (step 604). If the “marker” of the Solaris private field is an even digit, the “marker” indicates the listen request should be processed by the generic network adapter and the request is immediately forwarded to the Solaris network stack as shown in step 608. If the “marker” of the Solaris private field is an odd digit, the “marker” indicates the listen request should be processed by the TOE network adapter and the request is passed to step 606 where the address is mapped to kernel space by providing a local variable to the BSD function to fill in the address of the connecting host. The address is then translated and copied to the buffer provided by the operating system before the accept function returns to the operating system. The request is passed to step 612 where a sock_pair mapping is allocated from the private pointer with the least significant “marker” bit masked off. As shown in step 614, the BSD listen socket function may be called directly with the Solaris arguments since the arguments for the Solaris and BSD listen socket functions call map directly (excluding the version argument, which in not used by BSD). Finally, the resulting status is returned to Solaris in step 616, marking the end of the accept processing (step 618).

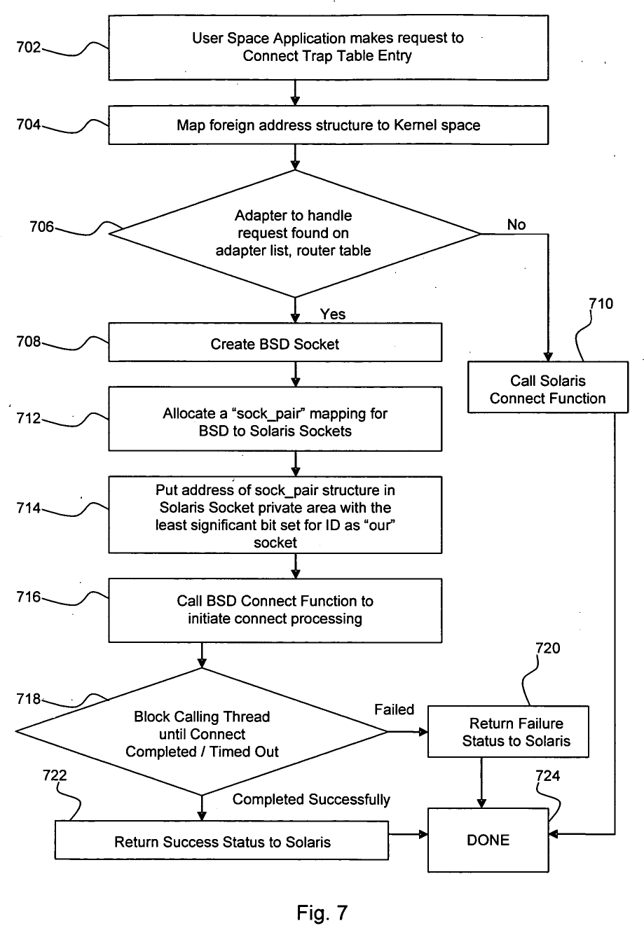

FIG. 7 is a flowchart illustrating the connect replacement socket function. The connect replacement socket function establishes a connection to a specified foreign address. Much of the processing is similar to the bind socket function described previously. When the user space application makes a request to the Solaris connect socket function that is routed to the corresponding trap table entry as shown in step 702, the user arguments, including the foreign address structure, supplied by the request are first mapped to kernel space as shown in step 704. Then, in step 706, the adapter list and route table are checked to determine the specified network adapter. If the address is directed to a generic network adapter, the bind call is passed through to the operating system's network stack as shown in step 710. If the address supplied matches the TOE network adapter's address, a BSD socket is created in step 708. After the BSD socket has been created, a mapping structure is allocated and initialized with the Solaris socket handle and the BSD socket pointer as shown in step 712. This step is known as a “sock_pair” mapping. Next, in step 714, the address of the sock_pair structure is placed in the Solaris socket private area with the least significant bit set as an identifier to indicate that this is “our” socket. Then, in step 716, the BSD connect socket function is called to initiate connect processing. At this point the calling thread blocks wait in a queue until the connect completes successfully or unsuccessfully, or until the connect times out (Step 718). If the connect fails or times out, a failure status is returned to the operating system as shown in step 720. Otherwise, if the connect completes successfully, a success status is returned to the operating system as shown in step 722. Once the failure or success status is returned to the operating system, the connect processing is completed (step 724).

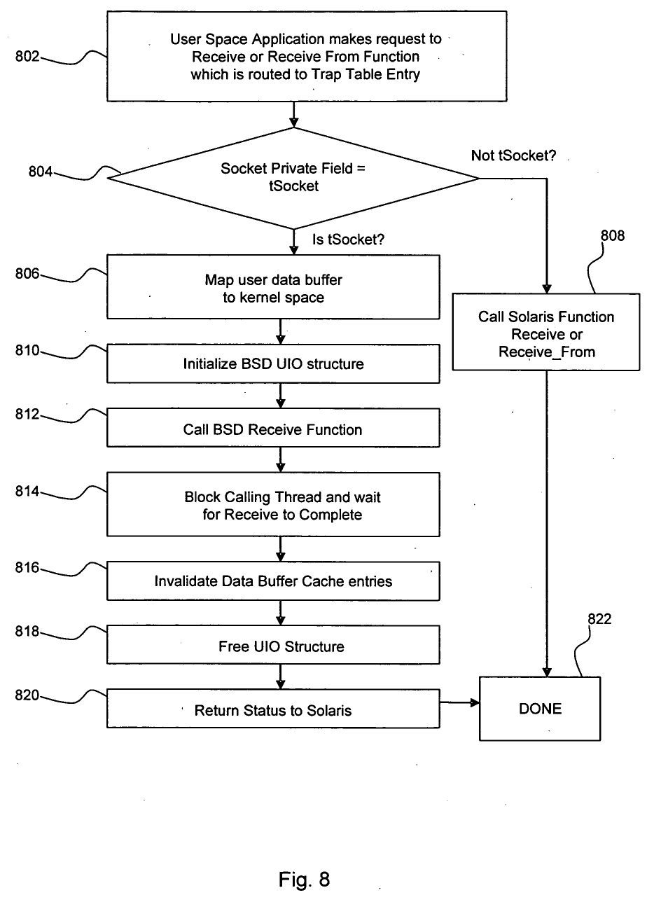

FIG. 8 is a flowchart illustrating the receive replacement socket function. The receive, or “recv”, socket replacement function transfers data from the socket receive buffer to the buffers provided by the call. When the user space application makes a request to the Solaris receive socket function that is routed to the corresponding trap table entry (step 802), the private field of the Solaris socket function is examined to determine whether the request should be handled by the Solaris network stack, for general network adapters, or sent to the TOE hardware's BSD receive function, for TOE network adapters as shown in step 804. If the private field of the Solaris socket function is not a “tSocket”, the socket has no association with the BSD socket and the Solaris networking stack is called directly as shown in step 808. If the private field of the Solaris socket function is a “tSocket”, the socket is associated with a BSD socket and the user data buffer is mapped into kernel space as shown in step 806. The buffer descriptor (buffer pointer and buffer length) are used to construct a User Input/Output (UIO) descriptor in step 810 that can be processed by the TOE hardware. The UIO descriptor is a private data structure in the TOE hardware that manages the I/O of the TOE network adapter. The resulting UIO and flags are then passed down to the TOE hardware via the BSD receive function for processing in step 812. Then, in step 814, the calling thread blocks wait in a queue for the receive to complete. Once the receive completes, the data buffer cache entries are invalidated in step 816 and the UIO structure is freed in step 818. Finally, the status is returned to Solaris in step 820 to complete the receive processing in step 822.

In one embodiment, FIG. 8 also depicts the receive from processing socket replacement function. The receive from, or “recvfrom”, socket function can be processed in the same manner as the receive function.

In another embodiment, FIG. 8 also depicts a flowchart of the send from processing socket replacement function. The send socket replacement function can be processed in much the same manner as the receive function. The only real difference in processing is that the BSD send socket replacement function is called instead of the receive socket replacement function.

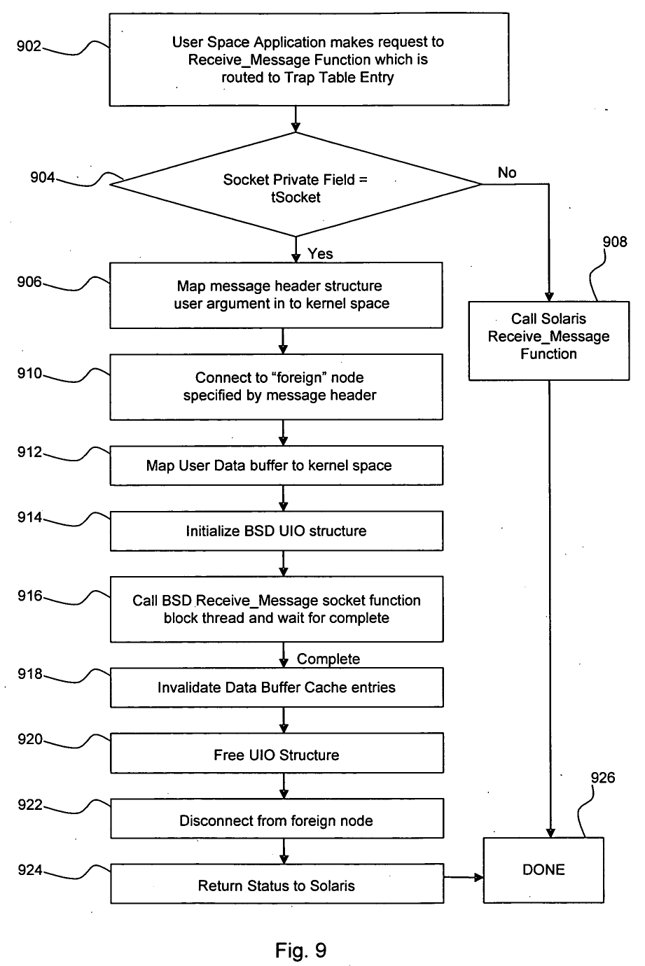

FIG. 9 is a flowchart illustrating a receive message socket replacement function. The receive message, or recvmsg, socket replacement function is processed in a similar manner to the recv function with the exception of the buffer descriptor being contained in a message header structure, or msghdr, instead of discretely specified with buffer pointer and buffer length arguments. When the user space application makes a request to the Solaris receive message socket function that is routed to the corresponding trap table entry (step 902), the private field of the Solaris socket is examined in step 904 to determine whether the request should be handled by the Solaris network stack, for generic network adapters, or sent to the TOE hardware's BSD receive_message function, for TOE network adapters. If the private field of the Solaris socket function is not a “tSocket”, the socket has no association with the BSD socket and the Solaris networking stack is called directly as shown in step 908. If the private field of the Solaris socket function is a “tSocket”, the socket is associated with a BSD socket and the message header structure user argument is mapped into kernel space as shown in step 906. A connection is then made to the foreign node specified in the message header (step 910). Next, in step 912, the user data buffer is mapped into kernel space and the buffer descriptor (buffer pointer and buffer length) are used to construct and initialize a UIO descriptor that can be processed by the TOE hardware as shown in step 914. The resulting UIO and flags are then passed down in step 916 to the TOE hardware via the BSD receive_message socket function for processing. The calling thread blocks then wait in a queue for the receive message to complete. Once it completes, the data buffer cache entries are invalidated as shown in step 918, thus freeing the UIO structure in step 920. Next, in step 922, a disconnect is made from the foreign node. Finally, in step 924, the status is returned to the operating system to complete the receive message socket function (step 926).

In one embodiment, FIG. 9 also depicts a flowchart illustrating a send message (sendmsg) socket replacement function. The sendmsg socket replacement function can be processed in much the same manner as the recvmsg socket function, except the BSD sendmsg socket function is used instead of the recvmsg socket function.

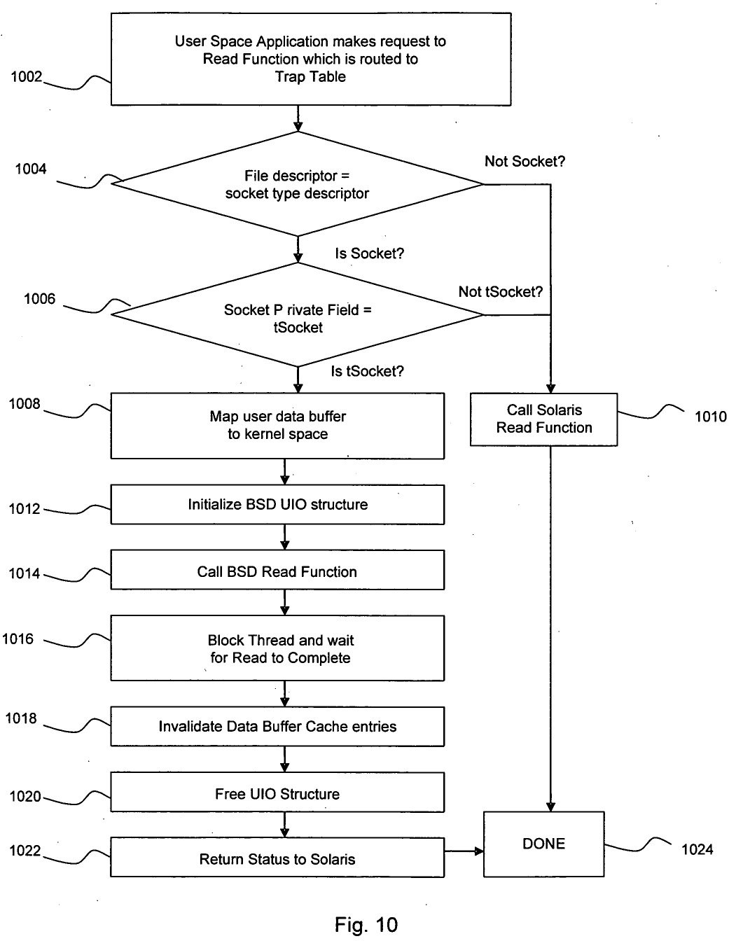

FIG. 10 is a flowchart illustrating a read socket replacement function. The read socket replacement function sends data in the established connection between open sockets. When the user space application makes a request to the Solaris read socket function that is routed to the corresponding trap table entry (step 1002), the private field of the Solaris socket is examined in step 1004 to determine whether the file descriptor of the request is a socket type descriptor. If the file descriptor is not a socket type descriptor, the Solaris networking stack is called directly as shown in step 1010. If the file descriptor is a socket type descriptor, the request is passed to step 1006 to determine whether the request should be handled by the Solaris network stack, for generic network adapters, or sent to the TOE hardware's BSD read function, for TOE network adapters. If the private field of the Solaris socket function is not a “tSocket”, the socket has no association with the BSD socket and the Solaris networking stack is called directly as shown in step 1010. If the private field of the Solaris socket function is a “tSocket”, the socket is associated with a BSD socket and the user data buffer is mapped into kernel space as shown in step 1008. Next, in step 1012, the buffer descriptor (buffer pointer and buffer length) are used to construct and initialize a UIO descriptor that can be processed by the TOE hardware. The resulting UIO and flags are then passed down in step 1014 to the TOE hardware via the BSD read socket function for processing. The calling thread blocks wait in a queue for the receive message to complete as shown in step 1016. Once it completes, the data buffer cache entries are invalidated as shown in step 1018, thus freeing the UIO structure in step 1020. Finally, in step 1022, the status is returned to the operating system to complete the receive message socket function (step 1024).

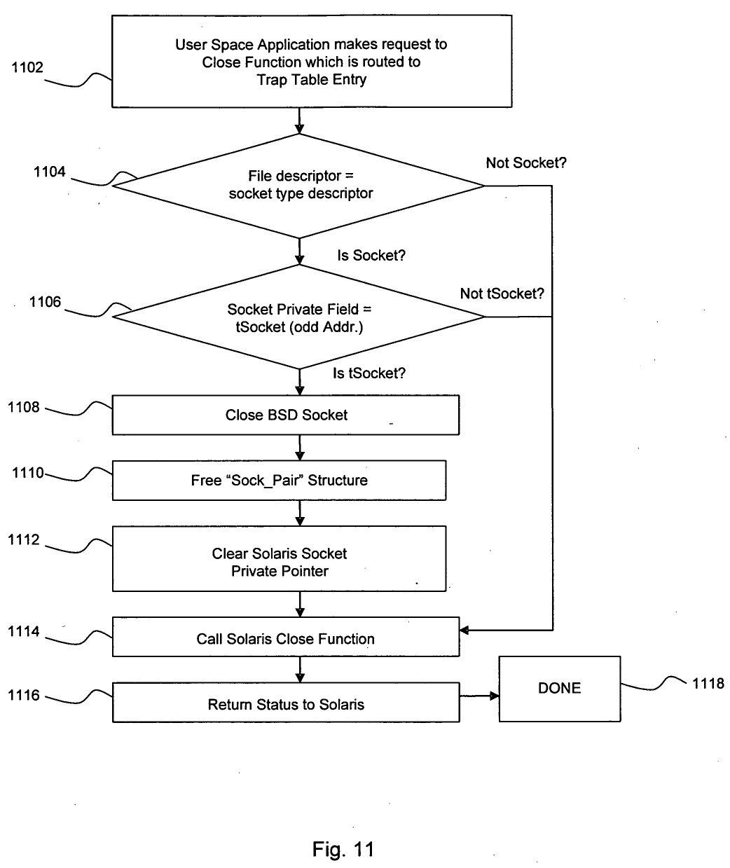

FIG. 11 is a flowchart illustrating a close socket replacement function. The close socket replacement function closes each end of a socket connection to terminate the open socket connection. When the user space application makes a request to the Solaris close socket function that is routed to the corresponding trap table entry (step 1102), the private field of the Solaris socket is examined in step 1104 to determine whether the file descriptor of the request is a socket type descriptor. If the file descriptor is not a socket type descriptor, the close socket function of the operating system is immediately called as shown in step 1114. If the file descriptor is a socket type descriptor, the request is passed to step 1106 to determine whether the request should be handled by the Solaris network stack, for generic network adapters, or sent to the TOE hardware's BSD read function, for TOE network adapters. If the private field of the Solaris socket function is not a “tSocket”, the socket has no association with the BSD socket and the close socket function of the operating system is immediately called as shown in step 1114. If the private field of the Solaris socket function is a “tSocket”, the socket is associated with a BSD socket and the close socket function of the BSD is called as shown in step 1108. Next, in step 1010, the sock_pair mapping, allocated by any of the bind, accept, listen, or connect socket functions of FIGS. 4, 5, 6, or 7, is freed. The private pointer of the operating system socket is cleared in step 1112. Then, the close socket function of the operating system is called as shown in step 1114. Finally, in step 1116, the status is returned to the operating system to complete the receive message socket function (step 1118).

In some embodiments, other socket replacement functions can be present. For completion, these socket functions will now be addressed.

The sosocket socket replacement function can create a new socket but does not provide addressing information. Thus, the TOE network driver cannot determine if the request is targeted for TOE hardware or generic hardware. As a result, this socket function is not replaced in the system trap table.

The so_socketpair socket replacement function can request that a duplicate socket be created. This call can also be passed directly to the operating system's network stack.

The shutdown socket replacement function can close part or all of a socket connection. The shutdown function checks the private field of the Solaris socket to determine whether the socket is paired with a BSD socket which would indicate the socket if targeted for the TOE hardware. As with the other socket functions, if the Solaris socket is not paired with a BSD socket, the request is immediately forwarded to the Solaris networking stack. If the Solaris socket is paired with a BSD socket, the BSD socket is called with the incoming arguments.

The sendto socket replacement function can send data to the specified foreign address. The sendto socket replacement function checks the private field of the Solaris socket to determine whether the socket is mapped to the BSD socket, indicating that the socket is targeted for the TOE hardware. If the socket indicates that it is not associated with the TOE hardware, the request is immediately forwarded to the Solaris network stack. If the socket is associated with a BSD socket, the buffer descriptor (buffer pointer and buffer length) are used to construct a UIO descriptor that can be processed by the TOE hardware. Then the address structure is modified from a Solaris address to a BSD address by copying the address information, excluding the length field, to a locally allocated BSD structure. The length argument (namelen) is then copied to the length field of the BSD address. The request can then be sent to the TOE hardware's sendto function.

The getpeername socket replacement function can query the socket for a foreign address. The foreign address can be extracted from the BSD socket, whose address is maintained in the BSD to Solaris mapping structure and formatted to fit in the Solaris address structure. The family field in the BSD sockaddr structure can be converted from a byte field to a short field in the Solaris sockaddr structure. The len field in the BSD sockaddr structure can be copied to the Solaris namelen argument.

The getsockname socket replacement function can query the socket for the local address. The processing can operate in the same manner as that of getpeername.

The getsockopt socket replacement function can query the socket for option information. The Solaris arguments are the same as the BSD arguments and can be passed directly to the TOE hardware.

The setsockopt socket replacement function can set option flags in the socket. The setsockopt socket replacement function can operate in the same manner as that of getsockopt.

The sockconfig socket replacement function is not supported by the BSD interface, so the request can be passed immediately to the operating system network stack.

While embodiments and implementations of the invention have been shown and described, it should be apparent that many more embodiments and implementations are within the scope of the invention. Accordingly, the invention is not to be restricted, except in light of the claims and their equivalents.

What is claimed is:

1. A method for processing network requests received by a computer comprising:
replacing original socket functions with replacement socket functions;
intercepting, at a system trap table having driver entry points pointing to the replacement socket functions, a socket request transmitted from an application program;
determining whether the structure of the socket request contains an encoded pointer, wherein
if the structure of the socket request contains an encoded pointer, the socket request is passed to TOE hardware for processing, and
if said structure of the socket request does not contain an encoded pointer, the socket request is directed to a generic network adapter for processing.

2. The method of claim 1, wherein the replacement socket functions are configured to snoop a socket request structure to determine whether the encoded pointer is present.

3. The method of claim 1, wherein said TCP offload engine network adapter is a fill TCP offload engine network adapter.

4. The method of claim 1, wherein said TCP offload engine network adapter is a partial TCP offload engine network adapter.

5. The method of claim 1, wherein said system trap table is positioned in an upper layer of kernel space, between said application program in user space and a function router in kernel space.

6. The method of claim 1, upon loading a device driver, original pointer pointing to the original socket functions are replaced with driver entry points pointing to the replacement socket function.

7. The method of claim 1, wherein original socket functions are saved in memory.

8. The method of claim 7, wherein the replacement socket functions contain pointers to the original socket functions.

9. The method of claim 8, wherein if the replacement socket function determines that the socket request structure does not include an encoded pointer in its private field, the replacement socket function initializes the pointer to the original socket request.

10. The method of claim 1, wherein said socket request is any I/O request.

11. A computer system for processing network requests comprising:
a computer running an operating system and having access to at least one server computer via a network for receiving requests;
said computer transmitting said requests to a system trap table;
said system trap table having substituted driver entry points that point to replacement socket functions for processing request directed to a TCP offload engine network adapter, wherein said replacement socket function is configured to determine whether the structure of the socket requests contains an encoded pointer and if said request structure contains said encoded pointer, the request is directed the TCP offload engine network adapter for processing.

12. The system of claim 11, wherein said system trap table is positioned in an upper layer of kernel space, between said application program in user space and a function router in kernel space.

13. The system of claim 11, wherein original system trap table pointer entries for processing original socket functions are saved in memory for future replacement.

14. A computer program product for enabling a computer to process network I/O requests comprising:
software instructions for enabling the computer to perform predetermined operations, and
a computer readable medium bearing the software instructions;
the predetermined operations including the steps of:
replacing original socket functions with replacement socket functions;
intercepting, at a system trap table having driver entry points pointing to the replacement socket functions, a socket request transmitted from an application program;
determining whether the structure of the socket request contains an encoded pointer, wherein
if the structure of the socket request contains an encoded pointer, the socket request is passed to TOE hardware for processing, and
if said structure of the socket request does not contain an encoded pointer, the socket request is directed to a generic network adapter for processing.

15. A computer system adapted to processing network I/O requests, comprising:
a processor;
a memory;
including software instructions adapted to enable the computer system to perform the steps of:
replacing original socket functions with replacement socket functions;
intercepting, at a system trap table having driver entry points pointing to the replacement socket functions, a socket request transmitted from an application program;
determining whether the structure of the socket request contains an encoded pointer, wherein
if the structure of the socket request contains an encoded pointer, the socket request is passed to TOE hardware for processing, and
if said structure of the socket request does not contain an encoded pointer, the socket request is directed to a generic network adapter for processing.
